(19) United States
(12) Patent Application Publication
(10) Pub. No.: US 2009/0136773 A1
(43) Pub. Date: May 28, 2009

(54) Barrier Coatings for the Label Stock

(76) Inventors: Tamal Ghosh, Hopewell Junction, NY (US); Philip De Somer, Merelbeke (BE)

Correspondence Address: JoAnn Villiamizar;Patent Department, 540 White Plains Road, P O Box 2005, Tarrytown, NY, 10591-9005, US

(21) Appl. No.: 12/083,556

(22) PCT Filed: Oct. 9, 2006
(86) PCT No.: PCT/EP2006/067171

§ 371 Date: Apr. 14, 2008

(30) Foreign Application Priority Data
Oct. 20, 2005 (EP) 05109791.3

(51) Int. Cl. B32B 27/28; B05D 1/36; B32B 33/00

(52) U.S. Cl. 428/500; 427/407.1; 156/90

(57) ABSTRACT

The present invention provides a label comprising a label stock (1), an adhesive layer (2), and a barrier coating layer (3), which is located between the bottom side of the label stock and the top side of the adhesive layer, wherein the barrier coating layer comprises either an acrylic core shell polymer or an organic perfluorochemical.

The present invention refers to the preparation and use of barrier coatings to improve adhesive holdout on a substrate.

Labels have adhesive on the bottom side of the “label stock” (also called “face stock”, “paper stock” or “base stock”). Some adhesive is always absorbed by the label stock and thus lost. As adhesive perhaps is one of the most expensive components of the label, there is a need to reduce the loss of adhesive due to absorption. Further, the excess adhesive that permeates to the top side of the label stock may lower the brightness as well as the print quality of the label. The adhesive can also be considered as a troublesome component in the paper recycling process.

In order to avoid loss of adhesive due to absorption by the label stock, the bottom side of the label stock is usually coated with a barrier coating layer, before being treated with the adhesive. Common barrier coatings for the label stock are composed of styrene acrylic (SA) polymer and starch or styrene butadiene (SB) polymer and starch. The disadvantage of these coatings is that still a considerable amount of adhesive is absorbed, and thus a high amount of adhesive is needed in order to achieve a sufficient peel force.

It is an object of the present invention to provide labels having a barrier coating layer that efficiently prevents the absorption of adhesive by the label stock, and thus only a reduced amount of adhesive is needed in order to achieve a sufficient peel force.

This object is solved by a label comprising a label stock (1), an adhesive layer (2) and a barrier coating layer (3), which is located between the bottom side of the label stock and the top side of the adhesive layer, wherein the barrier coating layer comprises either an acrylic core shell polymer or an organic perfluorochemical.

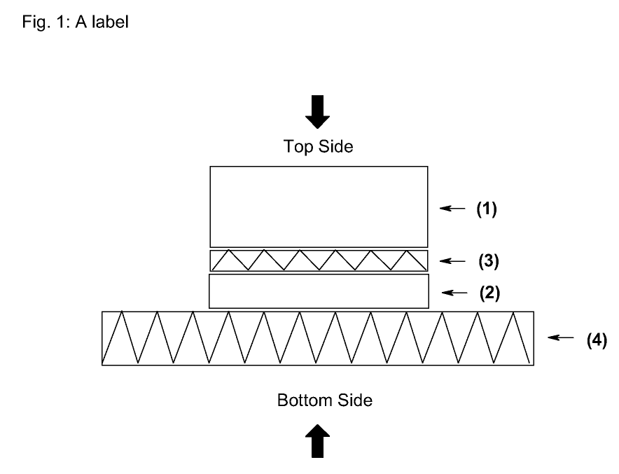

FIG. 1 shows a scheme of a label comprising a label stock (1), an adhesive layer (2) and a barrier coating layer (3). This scheme serves as a non limiting demonstration of the label of the present invention.

An acrylic core shell polymer comprises an acrylic core polymer and an acrylic shell polymer surrounding the acrylic core polymer.

The acrylic core polymer can have a weight average molecular weight (M_{W}) of from 75,000 g/mol to 350,000 g/mol, preferably from 80,000 g/mol to 200,000 g/mol, more preferably from 90,000 g/mol to 150,000 g/mol. The acrylic core polymer can have a glass transition temperature (Tg) of below 50° C., preferably of below 30° C., more preferably of below 20° C.

The glass transition temperature may be determined using differential scanning calorimetry.

The acrylic core polymer can be a copolymer formed from at least one acrylic monomer and at least one styrene monomer and optionally other ethylenically unsaturated monomers.

Acrylic monomers can be (meth)acrylic acid or salts thereof, (meth)acrylamide, (meth)acrylonitrile, C₁₋₂₀-alkyl (meth)acrylates or C₁₋₂₀-alkyl (meth)acrylamides,

whereby C₁₋₂₀-alkyl may be unsubstituted or substituted with hydroxy, amino, halogen, carboxy, sulfo, epoxy, C₁₋₁₀-alkoxy, O—CO—(C₁₋₁₀-alkyl), O—CO—(C₂₋₁₀-alkenyl), acetoacetoxy, CO—(C₁₋₁₀-alkoxy), NR¹R² or NR¹R²R³X,
whereby R¹, R² and R³ can be the same or different and are hydrogen, C₁₋₁₀-alkyl, C₅₋₈-cyclo-alkyl, aralkyl or aryl, or R¹ and R² together with the nitrogen to which they are attached form a heterocyclic ring, and X can be halogen or methylsulfate,
whereby C₁₋₁₀-alkyl or C₂₋₁₀-alkenyl may be unsubstituted or substituted with hydroxy, amino, halogen, carboxy, sulfo, epoxy, C₁₋₁₀-alkoxy, O—CO—(C₁₋₁₀-alkyl), acetoacetoxy, CO—(C₁₋₁₀-alkoxy), NR¹R² or NR¹R²R³X.

Salts of (meth)acrylic acid can be the alkaline metal or ammonium salts of (meth)acrylic acid or the salts formed by reacting (meth)acrylic acid with an amine of formula NHR¹R². Examples of alkaline metals are sodium or potassium.

C₁₋₂₀-Alkyl can be methyl, ethyl, propyl, isopropyl, butyl, sec-butyl, isobutyl, tert-butyl, pentyl, hexyl, heptyl, octyl, nonyl, decyl, undecyl, dodecyl, myristyl, palmityl, stearyl and arachinyl. C₁₋₁₀-Alkoxy can be methoxy, ethoxy, propoxy, isopropoxy, butoxy, sec-butoxy, isobutoxy, tert-butoxy, pentoxy, hexoxy, heptoxy, octoxy, nonoxy and decoxy. C₁₋₁₀-Alkyl can be methyl, ethyl, propyl, isopropyl, butyl, sec-butyl, isobutyl, tert-butyl, pentyl, hexyl, heptyl, octyl, nonyl and decyl. C₂₋₁₀-alkenyl can be vinyl or allyl. C₄₋₈-Alkyl can be cyclopentyl, cyclohexyl or cycloheptyl. Aralkyl can be benzyl and 2-phenylethyl. Aryl can be phenyl or naphthyl. The hetrocyclic ring can be piperazine, piperidine, pyrrolidine or morpholine. Halogen can be bromine or chlorine.

Examples of acrylic monomers are (meth)acrylic acid, (meth)acrylic acid, ammonium salt, (meth)acrylamide, ethyl (meth)acrylate, propyl (methacrylate), isopropyl (meth)acrylate, butyl (meth)acrylate, isobutyl (meth)acrylate, tert-butyl (meth)acrylate, hexyl (meth)acrylate, 2-ethylhexyl (meth)acrylate, glycidyl (meth)acrylate, 2-(dimethylamino)ethyl (meth)acrylate, 2-(dimethylamino)ethyl (meth)acrylate, methyl chloride quaternary salt, 2-(diethylamino)ethyl (meth)acrylate, (2-acetoacetoxy)ethyl (meth)acrylate, 2-(N-3-sulfopropyl)-N,N-dimethyl-ammonium)ethyl (meth)acrylate, mono-2-((meth)acryloyloxy)ethyl succinate, mono-2-((meth)acryloyloxy)ethyl maleate, [2-((meth)acryloyloxy)ethyl]trimethyl ammonium chloride, [2-((meth)acryloyloxy)ethyl]trimethylammonium methyl sulfate, [3-((meth)acryloylamino)-propyl]trimethylammonium chloride and 2-(meth)acrylamido-2-methyl-1-propane sulfonic acid

Preferred acrylic monomers are selected from the group consisting of (meth)acrylamide, C₁₋₂₀-alkyl (meth)acrylates and C₁₋₂₀-alkyl (meth)acrylamides,

whereby C₁₋₂₀-alkyl may be unsubstituted or substituted with hydroxy, amino, halogen, epoxy, C₁₋₁₀-alkoxy, O—CO—(C₁₋₁₀-alkyl), acetoacetoxy, CO—(C₁₋₁₀-alkoxy), NR¹R² or NR¹R²R³X,
whereby R¹, R² and R³ can be the same or different and are hydrogen, C₁₋₁₀-alkyl, C₅₋₈-cyclo-alkyl, aralkyl or aryl, or R¹ and R² together with the nitrogen to which they are attached form a heterocyclic ring, and X can be halogen or methylsulfate,
whereby C₁₋₁₀-alkyl may be unsubstituted or substituted with hydroxy, amino, halogen, epoxy, C₁₋₁₀-alkoxy, O—CO—(C₁₋₁₀-alkyl), acetoacetoxy, CO—(C₁₋₁₀-alkoxy), NR¹R² or NR¹R²R³X.

Examples of preferred acrylic monomers are (meth)acrylamide, ethyl (meth)acrylate, propyl (methacrylate), isopropyl (meth)acrylate, butyl (meth)acrylate, isobutyl (meth)acrylate, tert-butyl(meth)acrylate, hexyl (meth)acrylate, 2-ethylhexyl (meth)acrylate, glycidyl (meth)-acrylate, 2-(dimethylamino)ethyl (meth)acrylate, 2-(dimethylamino)ethyl (meth)acrylate, methyl chloride quaternary salt, 2-(diethylamino)ethyl (meth)acrylate, (2-acetoacetoxy)ethyl (meth)acrylate, [2-((meth)acryloyloxy)ethyl]trimethyl ammonium chloride, [2-((meth)acryl-oyloxy)ethyl]trimethylammonium methyl sulfate and [3-((meth)acryloylamino)propyl]trimethyl-ammonium chloride.

More preferred acrylic monomers are C₁₋₂₀-alkyl (meth)acrylates,

whereby C₁₋₂₀-alkyl may be unsubstituted or substituted with hydroxy, amino, halogen, epoxy, C₁₋₁₀-alkoxy, O—CO—(C₁₋₁₀-alkyl), acetoacetoxy, CO—(C₁₋₁₀-alkoxy), NR¹R² or NR¹R²R³X,
whereby R¹, R² and R³ can be the same or different and are hydrogen, C₁₋₁₀-alkyl, C₅₋₈-cyclo-alkyl, aralkyl or aryl, or R¹ and R² together with the nitrogen to which they are attached form a heterocyclic ring, and X can be halogen or methylsulfate,
whereby C₁₋₁₀-alkyl may be unsubstituted or substituted with hydroxy, amino, halogen, epoxy, C₁₋₁₀-alkoxy, O—CO—(C₁₋₁₀-alkyl), acetoacetoxy, CO—(C₁₋₁₀-alkoxy), NR¹R² or NR¹R²R³X.

Examples of more preferred acrylic monomers are ethyl (meth)acrylate, propyl (methacrylate), isopropyl (meth)acrylate, butyl (meth)acrylate, isobutyl (meth)acrylate, tert-butyl (meth)acrylate, hexyl (meth)acrylate, 2-ethylhexyl (meth)acrylate, glycidyl (meth)-acrylate, 2-(dimethylamino)ethyl (meth)acrylate, 2-(dimethylamino)ethyl (meth)acrylate, methyl chloride quaternary salt, 2-(diethylamino)ethyl (meth)acrylate, (2-acetoacetoxy)ethyl (meth)acrylate, [2-((meth)acryloyloxy)ethyl] trimethyl ammonium chloride and [2-((meth)acryl-oyloxy)ethyl]trimethylammonium methyl sulfate.

Even more preferred acrylic monomers are C₁₋₁₀-alkyl (meth)acrylates,

whereby C₁₋₁₀-alkyl may be unsubstituted or substituted with hydroxyl, epoxy, C₁₋₆-alkoxy, O—CO—(C₁₋₆-alkyl) or acetoacetoxy.
C₁₋₆-Alkoxy can be methoxy, ethoxy, propoxy, isopropoxy, butoxy, sec-butoxy, isobutoxy, tert-butoxy, pentoxy or hexoxy. C₁₋₆-Alkyl can be methyl, ethyl, propyl, isopropyl, butyl, sec-butyl, isobutyl, tert-butyl, pentyl or hexyl.

Examples of even more preferred acrylic monomers are ethyl (meth)acrylate, propyl (methacrylate), isopropyl (meth)acrylate, butyl (meth)acrylate, isobutyl (meth)acrylate, tert-butyl (meth)acrylate, hexyl (meth)acrylate, 2-ethylhexyl (meth)acrylate, glycidyl (meth)-acrylate and (2-acetoacetoxy)ethyl (meth)acrylate.

The most preferred acrylic monomers are C₁₋₁₀-alkyl (meth)acrylates.

Examples of most preferred acrylic monomers are ethyl (meth)acrylate, propyl (methacrylate), isopropyl (meth)acrylate, butyl (meth)acrylate, isobutyl (meth)acrylate, tert-butyl (meth)acrylate, hexyl (meth)acrylate and 2-ethylhexyl (meth)acrylate.

Styrene monomers can be styrene, which may be unsubstituted or substituted with hydroxy, amino, halogen, carboxy, sulfo, C₁₋₁₀-alkyl, C₁₋₁₀-alkoxy, O—CO—(C₁₋₁₀-alkyl), CO—(C₁₋₁₀-alkoxy) or NR⁴R⁵,

whereby R⁴ and R⁵ can be the same or different and are hydrogen, C₁₋₁₀-alkyl, C₅₋₈-cyclo-alkyl, aralkyl or aryl,
whereby C₁₋₁₀-alkyl may be unsubstituted or substituted with hydroxy, amino, halogen, carboxy, sulfo, C₁₋₁₀-alkoxy, O—CO—(C₁₋₁₀-alkyl), CO—(C₁₋₁₀-alkoxy) or NR⁴R⁵.

Examples of styrene monomers are styrene and 4-methylstyrene.

Preferred styrene monomers can be styrene, which may be unsubstituted or substituted with hydroxy, halogen, carboxy, sulfo, C₁₋₁₀-alkyl, C₁₋₁₀-alkoxy, O—CO—(C₁₋₁₀-alkyl) or CO—(C₁₋₁₀-alkoxy),

whereby C₁₋₁₀-alkyl may be unsubstituted or substituted with hydroxy, halogen, carboxy, sulfo, C₁₋₁₀-alkoxy, O—CO—(C₁₋₁₀-alkyl) or CO—(C₁₋₁₀-alkoxy).

More preferred styrene monomers can be styrene, which may be unsubstituted or substituted with C₁₋₁₀-alkyl,

whereby C₁₋₁₀-alkyl may be unsubstituted or substituted with C₁₋₁₀-alkoxy, O—CO—(C₁₋₁₀-alkyl) or CO—(C₁₋₁₀-alkoxy).

Most preferred styrene monomers can be styrene, which may be unsubstituted or substituted with C₁₋₆-alkyl.

The other ethylenically unsaturated monomers can be vinyl monomers, allyl monomers, olefin monomers and maleic monomers.

Examples of vinyl monomers are vinyl alcohol, vinyl chloride, vinyl isobutyl ether and vinyl acetate. An example of an allyl monomer is diallyldimethylammonium chloride. Examples of olefin monomers are ethylene, propylene, butadiene and isoprene. Examples of maleic monomers are maleic acid, maleic anhydride and maleimide.

Preferably, the acrylic core polymer is a copolymer formed from at least one acrylic monomer and at least one styrene monomer.

The ratio (w/w) of styrene monomer/acrylic monomer of the acrylic core polymer can be from 1/99 to 99/1, preferably from 20/80 to 80/20, more preferably from 50/50 to 60/40.

Examples of acrylic core polymers are copolymers formed from 50/50 (w/w) styrene/butyl acrylate, from 55/45 (w/w) styrene/butylacrylate, from 60/40 (w/w) styrene/2-ethylhexyl acrylate, from 30/30/40 (w/w/w) styrene/methyl methacrylate/2-ethylhexyl acrylate and from 55/45 (w/w) styrene/2-ethylhexyl acrylate.

The acrylic shell polymer can have a weight average molecular weight (M_{W}) of from 2,000 g/mol to 50,000 g/mol, preferably from 3,000 g/mol to 20,000 g/mol, more preferably from 6,000 g/mol to 10,000 g/mol. The acrylic core polymer can have a glass transition temperature (Tg) of from 75 to 150° C., preferably of from 85 to 120° C., more preferably of from 95 to 110° C.

The acrylic shell polymer can be a copolymer formed from at least one acrylic monomer having an acid functionality or salts thereof, and at least one other ethylenically unsaturated monomer.

Acrylic monomer having an acid functionality can be (meth)acrylic acid, C₁₋₂₀-alkyl (meth)-acrylates or C₁₋₂₀-alkyl (meth)acrylamides, whereby C₁₋₂₀-alkyl is substituted with carboxy or sulfo, and C₁₋₂₀-alkyl can additionally be substituted with hydroxy, halogen, epoxy, C₁₋₁₀-alkoxy, O—CO—(C₁₋₁₀-alkyl), O—CO—(C₂₋₁₀-alkenyl), acetoacetoxy or CO—(C₁₋₁₀-alkoxy), whereby C₁₋₁₀-alkyl or C₂₋₁₀-alkenyl may be unsubstituted or substituted with hydroxy, halogen, carboxy, sulfo, epoxy, C₁₋₁₀-alkoxy, O—CO—(C₁₋₁₀-alkyl), acetoacetoxy or CO—(C₁₋₁₀-alkoxy).

Salts of above acrylic monomer having an acid functionality can be the alkaline metal or ammonium salts or the salts formed by reacting the acid with an amine of formula NHR¹R². Examples of alkaline metals are sodium or potassium.

Examples of acrylic monomers having an acid functionality or salts thereof are (meth)acrylic acid, (meth)acrylic acid, ammonium salt, 2-(N-3-sulfopropyl)-N,N-dimethylammonium)-ethyl(meth)acrylate, mono-2-((meth)acryloyloxy)ethyl succinate, mono-2-((meth)acryl-oyloxy)ethyl maleate and 2-(meth)acrylamido-2-methyl-1-propane sulfonic acid.

Preferred acrylic monomers having an acid functionality are (meth)acrylic acid or salts thereof.

Examples of preferred acrylic monomers having an acid functionality or salts thereof are (meth)acrylic acid, (meth)acrylic acid, ammonium salt and methacrylic acid, sodium salt.

The other ethylenically unsaturated monomers can be acrylic monomers, styrene monomers, vinyl monomers, allyl monomers, olefin monomers or maleic monomers.

Preferred other ethylenically unsaturated monomers can be acrylic monomers, styrene monomers, vinyl monomers, allyl monomers, olefin monomers or maleic monomers.

More preferred other ethylenically unsaturated monomers can be acrylic monomers, styrene monomers or olefin monomers.

Most preferred other ethylenically unsaturated monomers can be acrylic monomers or styrene monomers.

Examples of acrylic shell polymers are 65/35 (w/w) styrene/acrylic acid, ammonium salt; 43/43/14 (w/w/w) isobutyl methacrylate, methyl methacrylate/acrylic acid, ammonium salt; 43/43/14 (w/w/w) butyl acrylate, methyl methacrylate, acrylic acid, ammonium salt; and 80/20 (w/w) ethylene/acrylic acid, ammonium salt.

The ratio (w/w) of ethylenically unsaturated monomer/acrylic monomer having an acid functionality or salts thereof can be from 1/99 to 99/1, preferably from 10/90 to 90/10, more preferably from 50/50 to 85/15.

The ratio of acrylic shell polymer/acrylic core polymer is 10/90 to 90/10, preferably, it is 10/90 to 60/40, more preferably, it is 20/80 to 50/50, most preferably, it is 25/75 to 40/60.

A preferred acrylic core shell polymer is composed of 55/45 (w/w) styrene 2-ethylhexyl-acrylate copolymer having a weight average molecular weight (M_{W}) of around 100'000 g/mol, as determined by gel permeation chromatography, and a glass transition temperature (Tg) of 15° C., which functions as the core, and a 65/35 (w/w) styrene acrylic acid, ammonium salt copolymer having a weight average molecular weight (M_{W}) of around 8'000 g/mol, as determined by gel permeation chromatography, and a glass transition temperature of 105° C., wherein the ratio of shell copolymer/core copolymer is 30/70 (w/w).

The acrylic core shell polymer can be prepared by polymerizing the monomers forming the acrylic core polymer in the presence of the acrylic shell polymer and a suitable initiator.

Preferably, the acrylic shell polymer and a part of the initiator is charged to a vessel and the remaining initiator and the monomers are fed to the vessel. Usually, the polymerization is performed in water as solvent.

The initiator can be a peroxide, a persulfate, an azo compound, a redox couple or mixtures thereof. Preferably, the initiator is a persulfate, more preferably, it is ammonium persulfate.

Preferably, the molar ratio of initiator or initiators/monomer or monomers is between 0.0001% and 1%.

An organic perfluorochemical can be any organic compound being substituted with fully fluorinated di-, tri- or polyC₃₋₂₀-alkyl, C₃₋₂₀-cycloalkyl or C₃₋₂₀-alkenyl groups or mixtures thereof.

The fully fluorinated C₃₋₂₀-alkyl, C₃₋₂₀-cycloalkyl or C₃₋₂₀-alkenyl groups of the organic compound can be the same or different.

Examples of fully fluorinated C₃₋₂₀-alkyl groups are heptafluoropropyl, heptafluoroisopropyl, nonafluorobutyl, nonafluorosec-butyl, nonafluoroisobutyl, nonafluorotert-butyl, undecafluoro-pentyl and tridecafluorohexyl, pentadecafluoroheptyl, heptadecafluorooctyl, nonadeca-fluorononyl, henicosafluorodecyl, tricosafluoroundecyl, pentacosafluorododecyl, nonacosa-fluoromyristyl, tritriacontafluoropalmityl and heptatriacontafluorostearyl. Examples of C₃₋₂₀-cycloalkyl are fully fluorinated cyclopentyl and cyclohexyl. Examples of fully fluorinated C₃₋₃₀-alkenyl are fully fluorinated allyl, linolenyl, docosahexaenoyl, eicosapentaenoyl, linoleyl, arachidonyl and oleyl.

Preferably, the organic perfluorochemical is any organic compound being substituted with fully fluorinated di-, tri- or polyC₃₋₂₀-alkyl groups or mixtures thereof. More preferably, the organic perfluorochemical is any organic compound being substituted with fully fluorinated di-, tri- or polyC₅₋₂₀-alkyl groups or mixtures thereof.

The organic compound can comprise at least 6 carbon atoms. Preferably, it a monomer comprising 8 to 20 carbon atoms, or an oligomer comprising 10 to 100 carbon atoms.

Preferably, the organic compound is composed of units selected from the group consisting of C₁₋₂₀-alkane, C₄₋₁₀-cycloalkane, C₂₋₂₀-alkene, C₅₋₁₀-cycloalkene and C₃₋₁₀-aliphatic heterocycles, wherein the units can be directly linked or linked via N, NH, O or S bridging atoms and wherein the units can be unsubstituted or substituted with hydroxy, carboxy, sulfo, sulfato (—O—SO₂OH) or phosphato (—OPO(OH)₂).

Examples of C₁₋₂₀-alkanes are methane, ethane, propane, isopropane, butane, sec-butane, isobutane, tert-butane, pentane, hexane, heptane, octane, nonane, decane, undecane, dodecan, tridecan, tetradecane, pentadecone, hexadecane, heptadecona, octadecane, nonadecane and icosane. Examples of C₄₋₁₀-cycloalkanes are cyclobutane, cyclopentane, cyclohexane and cycloheptane. Examples of C₂₋₂₀-alkenes are propene, 1-butene, 2-butene, 1-pentene, 2-pentene, 1-hexene, 2-hexene, 3-hexene, 1-heptene and 1-octene. Examples C₅₋₁₀-cycloalkenes are cyclopentene and cyclohexene. C₃₋₁₀-Aliphatic heterocycles can be saturated or unsaturated, examples are morpholine, piperidine and pyrrolidine.

Examples of organic perfluorochemicals and of their process of preparation are listed in U.S. Pat. No. 5,491,261, examples 1 to 20, 22 to 25 and 27 to 32.

More preferably, the organic compound is composed of units selected from the group consisting of C₁₋₂₀-alkane, C₄₋₁₀-cycloalkane, C₂₋₂₀-alkene, C₅₋₁₀-cycloalkene and C₃₋₁₀-aliphatic heterocycles, wherein the units can be directly linked or linked via N, NH, O or S bridging atoms and wherein the units are at substituted with at least one carboxy group and can additionally be substituted with hydroxy, sulfo, sulfato (—O—SO₂OH) or phosphato (—OPO(OH)₂).

The most preferred organic fluorochemical and is a mixture of compounds having the following structure

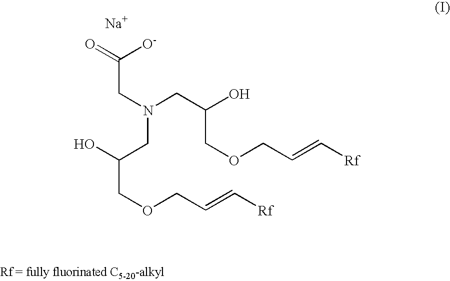

The barrier coating layer can comprise from 0.01 to 50% by dry weight acrylic core shell polymer or organic perfluorochemical/dry weight barrier coating layer. Preferably, it comprises from 0.1 to 10%, more preferably, from 1 to 5%, most preferably from 1.5 to 3% by dry weight acrylic core shell polymer/dry weight barrier coating layer. Preferably, it comprises from 0.01 to 10%, more preferably, from 0.03 to 5%, most preferably from 0.05 to 0.2% by dry weight organic perfluorochemical/dry weight barrier coating layer.

The barrier coating layer can comprise a film-forming polymer.

Examples of film-forming polymers are starch, modified starch, styrene butadiene (SB) polymer, styrene acrylic (SA) polymer, polyvinyl alcohol and polyvinyl acetate. More preferably, the additional component is starch or modified starch.

Typical sources of starch include cereals, tubers, roots and fruits. Examples of cereals are wheat, corn, rye, rice, barley, sorghum and oat. Examples of tubers and roots are potato, arrowroot and tapioca. Examples of fruits are chestnuts, peas, beans and bananas.

Modified starch can be obtained by chemical or physical modification of starch. Examples of chemically modified starch are partially or completely hydrolysed starch, oxidized starch, cationic starch, starch esters and cationic, nonionic and anionic starch ethers. Partially or completely hydrolysed starch can also be called converted starch and is usually obtained by enzyme treatment of starch such as the enzyme converted starch sold under the tradename Ciba® Raisamyl® 01121. Cationic starch is modified starch having a tertiary amino or quaternary ammonium group. Most cationic starches are cationic starch ethers. Examples of starch esters are starch nitrate, starch phosphate, starch acetate, starch citrate, starch succinate and starch adipate. Examples of starch ethers are hydroxyethyl starch and hydroxypropyl starch.

The barrier coating layer can comprise from 50 to 99.99% by dry weight of film forming polymer/dry weight barrier coating layer. Preferably, it comprises from 90 to 99.9%, more preferably, from 95 to 99.9%, most preferably from 97 to 99.9% by dry weight film forming polymer/dry weight barrier coating layer.

The barrier coating layer can comprise additional components such as biocides, defoamers, surfactants and colorants.

The barrier coating layer can comprise from 0.01 to 10% by dry weight additional component/dry weight barrier coating layer. Preferably, it comprises from 0.01 to 5%, more preferably, from 0.01 to 1%, most preferably from 0.01 to 0.5% by dry weight additional component/dry weight barrier coating layer.

The area weight of the barrier coating layer can be from 0.1 to 20 g/m². Preferably, it is from 0.5 to 10 g/m², more preferably, it is from 1 to 7 g/m².

The adhesive layer comprises adhesive, which can be any common adhesive, such as naturally occurring polymers, chemically modified derivatives of naturally occurring polymers, synthetic polymers and mixtures thereof.

Examples of naturally occurring polymers are polysaccharides such as starch, cellulose and natural gums, proteins or polypeptides such as casein or gelatine, and polyisoprenes such as natural rubber

Examples of natural gums are arabic gum, xanthan gum and guar gum.

Examples of chemically modified starch are given above.

Example of chemically modified cellulose are cellulose ethers such as methyl cellulose, carboxymethyl cellulose, ethyl cellulose, hydroxyethyl cellulose and hydroxypropyl cellulose, cellulose esters such as cellulose acteate, cellulose acetobutyrate, cellulose propionate, cellulose acetopropionate, cellulose nitrate and cellulose xanthogenate.

Examples of synthetic polymers are acrylic polymers, styrene polymers, vinyl polymers, polyolefins, polyamides, polyesters, polyurethanes, aldehyde polymers, epoxy polymers, polydisulfides, sulfone polymers and silicones.

Acrylic polymers can be polymers formed from at least one acrylic monomer or copolymers formed from at least one acrylic monomer and at least one other ethylenically unsaturated monomer such as styrene monomers, vinyl monomers, olefin monomers and maleic monomers or at least one naturally occurring polymer or chemically modified derivative thereof.

Examples of acrylic polymers are polyacrylate, styrene acrylic (SA) polymers, vinyl acetate acrylic polymers, acrylnitril butadiene rubber, cyano acrylate polymer, styrene acrylic starch polymers and acrylic starch polymers.

Styrene polymers can be polymers formed from at least one styrene monomer and copolymers formed from at least one styrene monomer and at least one other ethylenically unsaturated monomer which is not an acrylic monomer or at least one naturally occurring polymer or chemically modified derivative thereof. Examples of styrene polymers are styrene butadiene (SB) polymers including styrene butadiene, latex, carboxylated styrene butadiene polymers, styrene ethylene butadiene polymers, styrene butadiene styrene polymer, styrene ethylene propylene polymers and styrene butadiene starch polymers

Vinyl polymers can be polymers formed from at least one vinyl monomer or copolymers formed from at least one vinyl monomer and at least one other ethylenically monomer which is not acrylic monomer or a styrene monomer. Examples of vinyl polymers are polyvinyl alcohol (PVOH), polyvinyl acetate (PVAC), polyvinyl ether and ethylene vinyl acetate (EVA).

Polyolefins can be polymers formed from at least one olefin monomer. Examples of polyolefines are polybutadiene, polyisobutene, polyisoprene, butyl rubber, ethylene propylene rubber and polychloroprene.

Polyamides can be polymers formed from at least one monomer having an amide group or an amino as well as a carboxy group or from at least one monomer having two amino groups and at least one monomer having two carboxy groups. An example of a monomer having an amide group is caprolactam. An example of a diamine is 1,6-diaminohexane. Examples of dicarboxylic acids are adipic acid, terephthalic acid, isophthalic acid and 1,4-naphthalene-dicarboxylic acid. Examples of polyamides are poyhexamethylene adipamide and polycaprolactam.

Polyesters polymers can be formed from at least one monomer having a hydroxy as well as a carboxy group or from at least one monomer having two hydroxy groups and at least one monomer having two carboxy groups or a lactone group. An example of a monomer having a hydroxy as well as a carboxy group is adipic acid. An example of a diol is ethylene glycol. An example of a monomer having a lactone group is carprolactone. Examples of dicarboxylic acids are terephthalic acid, isophthalic acid and 1,4-naphthalenedicarboxylic acid. An example of a polyester is polyethylene terephthalate. So-called alkyd resins are also regarded to belong to polyester polymers.

Polyurethane can be polymers formed from at least one diisocyanate monomer and at least one polyol monomer and/or polyamine monomer. Examples of diisocyanate monomers are hexamethylene diisocyanate, toluene diisiocyanate and diphenylmethane diisocyanate.

Aldehyde polymers can be formed from at least one aldehyde and at least one monomer having a nucleophilc group group. Examples of formaldehyde polymers are phenol resorcinol formaldehyde, phenol formaldehyde, cresol formaldehyde, dicyandiamide formaldehyde, urea formaldehyde, thiourea formaldehyde, aniline formaldehyde, melamine formaldehyde and phenol furfural.

An example of an epoxy polymer is the reaction product of bisphenol A and epichlorohydrine.

Polysulfones can be polymers, wherein the repeating units are linked via sulfone groups. An example of a polysulfone is polyphenylsulfone.

Preferably, the adhesive is a synthetic polymer or mixture of synthetic polymers.

Preferred synthetic polymers are polyacrylates, styrene acrylic (SA) polymers, vinyl acetate acrylic polymers, styrene butadiene (SB) polymers and carboxylated styrene butadiene polymers.

The adhesive layer area weights can be from 1 to 50 g/m², preferably, from 5 to 30 g/m², more preferably from 8 to 25 g/m².

The label stock can be any paper having an area weight of from 30 to 230 g/m². The paper can be made from wood fibers (pulp) or other natural fibers such as cane trash or straw, cotton textiles, rags, synthetic fibers, mixtures of natural and synthetic fibers, mineral fibers, and/or recovered paper. Synthetic fibers can be made from polymers such as acrylic polymers, styrene polymers, polyolefines, polyamides, polyesters or polyurethans. Examples of acrylic polymers, styrene polymers, polyolefines, polyamides, polyesters or polyurethans are given above. Mineral fibers can be made, for example, from silicium nitride, silicium carbide, silicium dioxide, fiber glass, glass or boron.

The paper can include additives such as fillers (or pigments), dyes, binders, optical brightners, retention aids or deinking agents.

Examples of fillers (or pigments) are clay (or kaolin), calcined clay (or kaolin), ground calcium carbonate (GCC), precipitated calcium carbonate (PCC), titanium dioxide, satin white, zinc oxide, barium sulfate, gypsum, silica, alumina trihydrate, talc, mica and diatomaceous earth. Examples of dyes are organic pigment dyes, respectively anionic direct dyes as sold for example under the tradenames Ciba® Irgalite® and Ciba® Pergasol®. Examples of binders are natural binders such as starch, casein and rosin or synthetic binders such as latexes, e.g. styrene-butadiene (SB) latex or styrene-acrylate (SA) latex. An example of an optical brightener is diaminostilbenedisulfonic acid as sold for example under the tradename Ciba® Tinopal® UP. Examples of retention aids are aluminium sulfate or synthetic cationic polymers, as sold for example under the tradename Ciba® Percol.

Preferably, the label stock is a paper having an area weight of from 50 to 150 g/m², more preferably of from 60 to 100 g/m².

Preferably, the label stock is any paper made from wood fibers (pulp), other natural fibers and/or recovered paper. More preferably, the label stock is any paper made from wood fibers and/or recovered paper.

The bottom side of the adhesive layer of the label of the present invention can be attached to a substrate (4), as illustrated in FIG. 1.

The substrate can be any two or three dimensional object. The substrate can be made from paper, release paper, cardboard, metal, wood, textiles, glass, ceramics and/or polymers. Release paper can be made from glassine, high-density glassine or kraft. Usually a silicone layer is added to the top of the release paper. Preferably, the substrate is paper or release paper.

Also part of the invention is a process for preparing the label of the present invention comprising the steps of
(i) forming a barrier coating composition comprising the acrylic core shell polymer, respectively, the organic perfluorochemical and optionally film forming polymer and additional components,
(ii) applying the barrier coating composition of step (i) to a label stock to form the barrier coating layer, and
(iii) applying an adhesive to the barrier coating obtained in step (ii) to form the adhesive layer.

The barrier coating composition can be formed by mixing the acrylic core shell polymer, respectively, the organic perfluorochemical with the film forming polymer and optionally additional components.

Preferably, the barrier coating composition is formed by mixing the acrylic core shell polymer, respectively, the organic perfluorochemical as aqueous emulsion with an aqueous solution of starch or modified starch as film forming polymer having a temperature from 40 to 80° C., preferably from 60 to 70° C.

The barrier coating composition can comprise from 0.001 to 20%, preferably from 0.001 to 10%, more preferably from 0.005 to 5% by weight acrylic core shell polymer, respectively, the organic perfluorochemical/weight of the barrier coating composition.

The barrier coating composition can comprise from 1 to 60%, preferably from 10 to 40%, more preferably from 15 to 30% by weight film forming polymer/weight of the barrier coating composition.

The barrier coating composition can be applied to the label stock using a conventional coating technique such as bar (or rod) coater application, rotation application, spray application, curtain application, dip application, air application, knife application, blade application or roll application. Preferably, it is applied using a bar (or rod) coater.

After applying the barrier coating composition to the label stock, it can be dried to form the barrier coating layer. Usually it is dried using air drying at elevated temperature or infrared drying direct contact heated rolls.

The adhesive can be applied as a neat liquid or as a solvent or water-based solution, emulsion or dispersion. If the adhesive is a applied as a solution, emulsion or dispersion, this solution, emulsion or dispersion has a solid content of from 20% to 90% by weight, more preferably of from 30% to 80% by weight, most preferably of from 40% to 70% by weight. Preferred solvents are hydrocarbons, esters, ketones and mixtures thereof. Hydrocarbons can be alkanes, cycloalkanes, alkenes, cycloalkenes and aromates. Examples of esters are ethyl acetate or butyl acetate. An example of a ketone is methyl ethyl ketone. Preferably, the adhesive is applied as a neat liquid or as a water-based solution, emulsion or dispersion. More preferably, the adhesive is applied as a neat liquid or as a water-based emulsion.

The adhesive can be applied to the barrier coating using conventional coating or printing techniques. Examples of coating techniques are bar (or rod) coater application, rotation application, spray application, curtain application, dip application, air application, knife application, blade application or roll application. Examples of suitable printing techniques are gravure or flexographic techniques. Preferably, the adhesive is applied using a bar (or rod) coater.

If the adhesive is applied neat, it is usually melted before application and after application, cooled to form a solid adhesive layer. If the adhesive is applied as a solvent or water-based solution, emulsion or dispersion, this solution, emulsion or dispersion can be dried to form the adhesive layer.

If the label of the present invention is attached to a substrate, the process of preparation comprises the additional step of attaching the label via the bottom side of the adhesive layer to the substrate.

Also part of the invention is a label precursor which comprises a label stock, and a barrier coating layer on the bottom side of the label stock, wherein the barrier coating layer comprises either an acrylic core shell polymer or an organic perfluorochemical.

Another part of the invention is a process for preparing the label precursor of the present invention comprising the steps of
(i) forming a barrier coating composition comprising the acrylic core shell polymer, respectively, the organic perfluorochemical and optionally film forming polymer and additional components, and
(ii) applying the barrier coating composition of step (i) to a label stock to form a barrier coating layer.

Also part of the present invention is the use of acrylic core shell polymers or organic perfluorochemicals as a barrier coating layer additive for labels, and a method for reducing absorption of adhesive by the label stock in a label by applying a barrier coating layer between the bottom side of the label stock and the top side of the adhesive layer, wherein the barrier coating layer comprises either an acrylic core shell polymer or an organic perfluorochemical.

The label of the present invention has the advantage that it has a barrier coating layer that efficiently reduces the absorption of adhesive by the label stock, and thus only a reduced amount of adhesive is needed in order to achieve a sufficient peel force. In addition, only low amounts of acrylic core shell polymer, respectively, organic perfluorochemical in the barrier coating layer are necessary in order to achieve this result.

FIG. 1 shows a label comprising a label stock (1), an adhesive layer (2) and a barrier coating layer (3). The label is attached to a substrate (4).

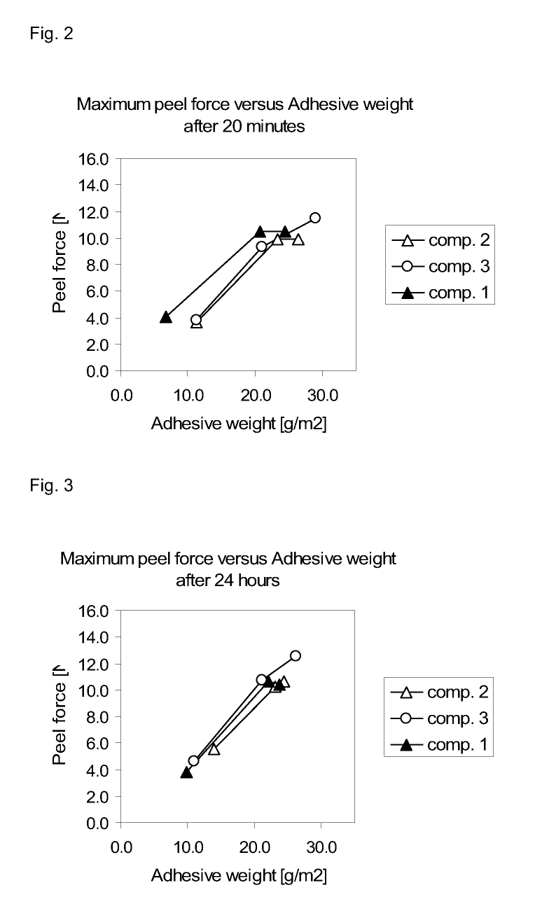

FIG. 2 shows the maximum peel force in N versus adhesive weight in g/m² needed to remove the comparative adhesive-treated sample 1 having a barrier coating containing solely starch, and the comparative adhesive-treated samples 2 and 3 having a barrier coating containing Ciba® Latexia® 302 from glass as a substrate at the pull distance from 40 to 90 mm after 20 minutes of bonding.

FIG. 3 shows the maximum peel force in N versus adhesive weight in g/m² needed to remove the comparative adhesive-treated sample 1 having a barrier coating containing solely starch, and the comparative adhesive-treated samples 2 and 3 having a barrier coating containing Ciba® Latexia® 302 from glass as a substrate at the pull distance from 40 to 90 mm after 24 hours of bonding.

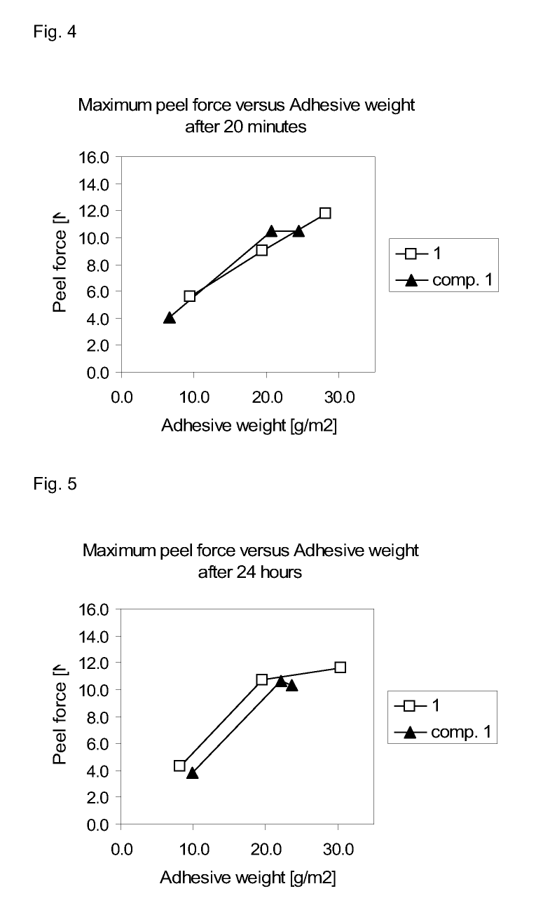

FIG. 4 shows the maximum peel force in N versus adhesive weight in g/m² needed to remove the adhesive-treated sample 1 of the present invention having a barrier coating containing an acrylic core shell polymer and the comparative adhesive-treated sample 1 (solely starch) from glass as a substrate at the pull distance from 40 to 90 mm after 20 minutes of bonding.

FIG. 5 shows the maximum peel force in N versus adhesive weight in g/m² needed to remove the adhesive-treated sample 1 of the present invention having a barrier coating containing an acrylic core shell polymer and the comparative adhesive-treated sample 1 (solely starch) from glass as a substrate at the pull distance from 40 to 90 mm after 24 hours of bonding.

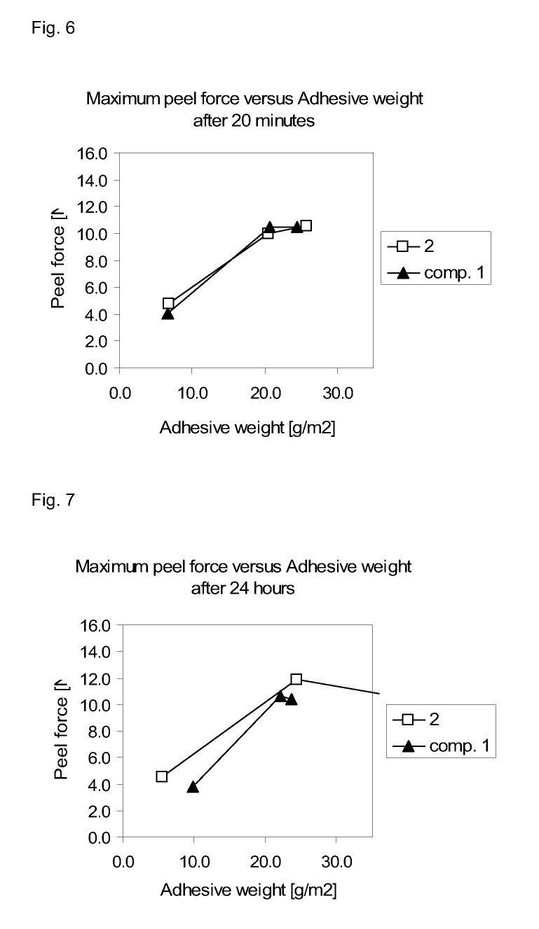

FIG. 6 shows the maximum peel force in N versus adhesive weight in g/m² needed to remove the adhesive-treated sample 2 of the present invention having a barrier coating containing organic perfluorchemical and comparative adhesive-treated sample 1 (solely starch) from glass as a substrate at the pull distance from 40 to 90 mm after 20 minutes of bonding.

FIG. 7 shows the maximum peel force in N versus adhesive weight in g/m² needed to remove the adhesive-treated sample 2 of the present invention having a barrier coating containing organic perfluorchemical and comparative adhesive-treated sample 1 (solely starch) from glass as a substrate at the pull distance from 40 to 90 mm after 24 hours of bonding.

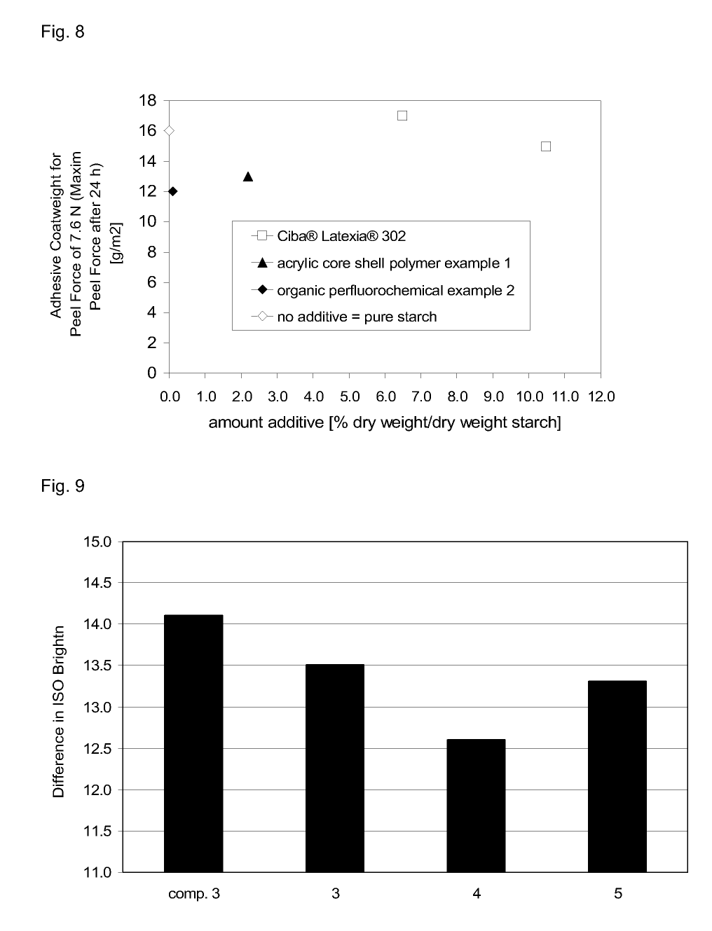

FIG. 8 shows the adhesive weight needed to attain a maximum peel force of 7.6 N for barrier-coated label-stock papers of the present invention coated with barrier coatings containing an acrylic core shell polymer, respectively, an organic perfluorochemical, and for control barrier-coated label-stock papers coated with a barrier coating containing Ciba® Latexia® 302 a, respectively, with a barrier coating containing solely starch.

FIG. 9 shows the difference in brightness between adhesive-treated and not-adhesive treated samples 3 to 5 having a barrier coating containing an acrylic core shell polymer (samples 3 and 4) or an organic perfluorochemical (sample 5) of the present invention and between comparative adhesive-treated and not-adhesive treated sample 3 having a barrier coating containing Ciba® Latexia® 204.

### EXAMPLES

### Example 1

### Preparation of an Acrylic Core Shell Polymer

Butyl acetate (250 g) is charged to a reactor and heated to reflux (125° C.). tert-Butyl per-benzoate (7.8 g) is added to the reactor. A monomer feed consisting of styrene (162.5 g) and glacial acrylic acid (87.5 g) is prepared. An initiator feed consisting of tert-butyl-perbenzoate (23.4 g) is prepared. The monomer feed is added to the reactor within 5 hours and the initiator feed is added to the reactor within 5.5 hours. Once the feeds are completed, the reaction mixture is held for a further 1 hour at 125° C. A mixture of 20% by weight aqueous ammonia (100 g) and water (700 g) is added to the reactor whilst distilling off butyl acetate. The distillate is split and the water returned to the reactor and the butyl acetate to the receiver. The temperature of the reaction mixture falls to 93° C. during distillation and rises to 100° C. when all the butyl acetate has been removed. When distillation is complete, the reaction mixture is cooled to below 40° C., the obtained solution of 65/35 (w/w) styrene/acrylic acid, ammonium salt is adjusted to 25% by weight solid content and pH 9.0.

The 25% by weight aqueous solution of styrene/acrylic acid, ammonium salt copolymer (576 g) and water (71 g) is charged to a reactor, heated to 85° C. and degassed with nitrogen for 30 minutes. Ammonium persulfate (0.5 g) is added. A monomer feed consisting of styrene (184.8 g) and 2-ethylhexyl acrylate (151.2 g) is prepared. An initiator feed consisting of ammonium persulfate (1.5 g) and water (15.0 g) is prepared. The monomer feed is added to the reactor within 3 hours and the initiator feed is added to the reactor within 4 hours. The temperature of the reaction mixture is kept at 85° C. during polymerisation. Once the feeds are completed, the contents is held for a further 1 hour at 85° C. before being cooled to below 40° C. and Acticide® LG, a biocide containing chlorinated and non-chlorinated methyl isothiazolones, (0.9 g) is added. The obtained core shell polymer consists of 70 weight parts 55/45 (w/w) styrene/2-ethylhexyl acrylate copolymer, which functions as the core polymer, and 30 weight parts 65/35 (w/w) styrene/acrylic acid, ammonium salt copolymer, which functions as the shell polymer. The core shell polymer is obtained as an aqueous emulsion having a solid content of about 46% (w/w), a pH of 8.5 and a viscosity at 25° C. (Brookfield 20 rpm) of 700 mPa×s.

### Example 2

### Preparation of the Organic Perfluorochemical of Formula (I)

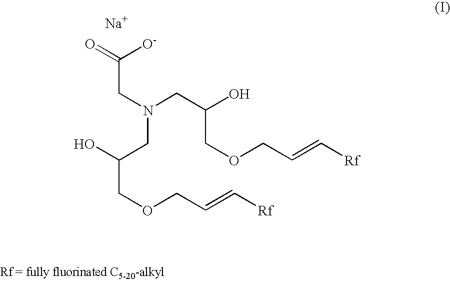

The organic fluorochemical of formula (I) is prepared in analogy to the organic perfluoro-chemical of example 32, U.S. Pat. No. 5,491,261, except that glycine instead of β-alanine is employed.

### Example 3A

### Preparation of Barrier-Coated Label-Stock Papers (=Samples)

Five barrier coating compositions, all containing starch, are prepared. Three of these barrier coating compositions are comparative coating compositions containing in addition to starch an acrylic polymer and two of these barrier coating compositions belong to the present invention containing in addition to starch either an acrylic core shell polymer or an organic fluorochemical (see table 1 below). Comparative coating composition 1 containing solely starch is prepared by cooking Ciba® Raisamyl® 01121, which is enzyme converted starch, as an aqueous solution on a heating plate. Comparative coating compositions 2 and 3, and coating composition 1 are prepared by adding the additive Ciba® Latexia® 302, a styrene acrylate latex, respectively, the acrylic core shell polymer (ACSP) obtained as described in example 1, to hot (ca. 60° C.) aqueous Ciba® Raisamyl® 01121 solution under high shear mixing. Coating composition 2 is prepared by adding as additive the organic perfluorochemical (OPFC) of formula (I) obtained as described in example 2 to hot (ca. 60° C.) aqueous Ciba® Raisamyl® 01121 solution under medium shear mixing.

The barrier coating compositions are heated to 60 to 70° C., the Brookfield viscosity of the hot barrier coating compositions is measured at 20 rpm. The hot barrier coating compositions are applied to paper (label stock) having a weight of 70 g/m² using a bar coater (1 bar, speed 8), and dried using an infrared drier and air drying at 150° C. to form the barrier coating layers.

TABLE 1
Ciba ® Latexia ® 302, a carboxylated styrene butadiene
latex having a solid content of 50% (w/w) and a pH of 5.5.

| | Barrier coating composition | | | | | Barrier |
|---|---|---|---|---|---|---|
| | | Dry weight | | | | coating |
| | Additive | additive/ | | Solid | Brookfield | Coat |
| Sample | (in addition | dry weight | | content | viscosity | weight |
| No. | to starch) | starch [%] | pH | [%] | [mPa × s] | [g/m²] |
| comp. 1 | None | — | 6.2 | 27.0 | 340 (65° C.) | 5.0 |
| comp. 2 | Ciba ® | 6.4 | 6.0 | 27.3 | 438 (70° C.) | 5.0 |
| | Latexia ® 302 | | | | | |
| comp. 3 | Ciba ® | 10.6 | 5.9 | 29.0 | 870 (65° C.) | 5.5 |
| | Latexia ® 302 | | | | | |
| 1 | ACSP | 2.2 | 6.9 | 28.0 | 280 (65° C.) | 4.5 |
| 2 | OPFC | 0.1 | 6.2 | 28.9 | 434 (60° C.) | 5.5 |

ACSP is the acrylic core shell polymer obtained as described in example 1 in form of an aqueous emulsion having a solid content of about 46% (w/w). OPFC is the organic perfluorochemical of formula (I) obtained as described in example 2 in form of an aqueous emulsion having a solid content of 20% (w/w).

### Example 3B

### Preparation of Barrier-Coated Label-Stock Papers (=Samples)

Four barrier coating compositions, all containing starch, are prepared. One of these barrier coating compositions is a comparative coating composition containing in addition to starch an acrylic polymer and three of these barrier coating compositions belong to the present invention containing in addition to starch either an acrylic core shell polymer or an organic fluorochemical (see table 1 below). Comparative coating composition 4, and coating compositions 3 and 4 are prepared by cooking Ciba® Raisamyl® 01121, which is enzyme converted starch, as an aqueous solution on a heating plate, and then adding the additives Ciba® Latexia® 204, a styrene acrylate latex, respectively, the acrylic core shell polymer (ACSP) obtained as described in example 1, to hot (ca. 60° C.) aqueous Ciba® Raisamyl® 01121 solution under high shear mixing. Coating composition 5 is prepared by adding as additive the organic perfluorochemical (OPFC) of formula (I) obtained as described in example 2 to hot (ca. 60° C.) aqueous Ciba® Raisamyl® 01121 solution under medium shear mixing.

The barrier coating compositions are heated to 60 to 70° C., the Brookfield viscosity of the hot barrier coating compositions is measured at 20 rpm. The hot barrier coating compositions are applied to paper (label stock) having a weight of 70 g/m² using a bar coater (1 bar, speed 8), and dried using an infrared drier and air drying at 150° C. to form the barrier coating layers.

TABLE 2
Ciba ® Latexia ® 204, a styrene acrylate
latex having a solid content of 50% (w/w) and a pH of 7.

| | Barrier coating composition | | | | | Barrier |
|---|---|---|---|---|---|---|
| | | Dry weight | | | Brookfield | coating |
| | Additive | additive/ | | Solid | viscosity | Dry Coat |
| Sample | (in addition | dry weight | | content | (20 RPM) | weight |
| No. | to starch) | starch [%] | pH | [wt. %] | [mPa × s] | [g/m²] |
| comp. 4 | Ciba ® | 8.8 | 6.4 | 29.0 | 410 | 5 |
| | Latexia ® 204 | | | | | |
| 3 | ACSP | 2.2 | 7.0 | 28.0 | 340 | 5 |
| 4 | ACSP | 6.6 | 7.3 | 27.2 | 280 | 5 |
| 5 | OPFC | 0.1 | 6.2 | 27.0 | 340 | 5 |

ACSP is the acrylic core shell polymer obtained as described in example 1 in form of an aqueous emulsion having a solid content of about 46% (w/w). OPFC is the organic perfluorochemical of formula (I) obtained as described in example 2 in form of an aqueous emulsion having a solid content of 20% (w/w).

### Example 4A

### Preparation of Adhesive-Treated Barrier-Coated Label-Stock Paper (=Adhesive-Treated Samples) Using Emulsion Water-Based Adhesive

A standard emulsion water-based styrene acrylic copolymer adhesive having a solid content of 52% (w/w) is applied on the coated label-stock papers obtained as described in example 3A using a metering device (RK Meyer Bar) and three different coating bars (24 μm, 40 μm and 50 μm). After applying the adhesive, the adhesive covered coated label-stock papers are cured between sheets of silicone release paper in an oven at 80° C. for 20 minutes. The samples are removed from the oven and the silicone paper is discarded. Fresh silicone paper is then gently applied to the cured adhesive surface to protect it until testing. The adhesive weight is calculated by substracting the oven-dry weight of an area of the barrier-coated label-stock paper from the oven-dry weight of an equivalent area of the adhesive-treated barrier-coated label-stock paper.

The adhesive weights obtained using the 24 μm coating bar are about 10 g/m², the adhesive weights obtained using the 40 μm coating bar are about 20 g/m² and the adhesive weights obtained using the 50 μm coating bar are about 27 g/m².

### Peel Testing of the Adhesive-Treated Samples of Example 4A

The adhesive-treated samples obtained as described in example 4A are bonded against glass as substrate. The peel force, which is the force needed to remove the sample, is measured after 20 minutes and 24 hours, respectively, using a Hoensfield tensile tester and following industrial test method FINAT standard test method 2 (90° peel adhesion (300 m/min)). The 20 minutes peel test measures the immediate bond. The 24 hours peel test measures the ultimate bond strength as bonding develops over time. During the 24 hours period, the samples are stored at controlled temperature and humidity (23° C., 50% relative humidity). The peel forces measured at the pull distance from 40 to 90 mm are used to determine the maximum peel force of the adhesive-treated sample. It can be assumed that the higher the maximum peel force is, the less adhesive has penetrated through the barrier coating layer into the label stock.

The peel force in N versus the adhesive weights in g/m² after 20 minutes, respectively, 24 hours of bonding of the samples to glass is shown in FIGS. 2 to 7.

After 20 minutes of bonding the maximum peel force of the adhesive-treated samples containing the acrylic core shell polymer as additive (FIG. 4, sample 1), respectively, the organic perfluorochemical as additive in the barrier coating (FIG. 6, sample 2) show a higher maximum peel force than the samples containing Ciba® Latexia® 302 as additive (FIG. 2, comp. 2 and comp. 3) for a given adhesive weight, and also a higher maximum peel force at low adhesive weights than the sample containing solely starch (FIGS. 4 and 6, comp. 1).

After 24 hours of bonding the adhesive-treated samples containing the acrylic core shell polymer as additive (FIG. 5, sample 1), respectively, the organic perfluorochemical as additive (FIG. 7, sample 2) in the barrier coating show considerable higher maximum peel forces than the sample containing solely starch (FIGS. 5 and 7, comp. 1) and also than the samples containing 6.5%, respectively, 10.6% by dry weight Ciba® Latexia® 302/dry weight starch (FIG. 3, comp. 2 and comp. 3) for a given adhesive weight. This means, that less adhesive penetrates through the barrier coatings containing 2.2% by dry weight of the acrylic core shell polymer or 0.1% by dry weight of the organic perfluorochemical compared to 6.5%, repectively, 10.6% dry weight Ciba® Latexia® 302, all based on dry weight of starch, into the label stock. This effect, is in general, more pronounced at low adhesive weights.

In addition, the samples of the present invention containing the acrylic core shell polymer or the organic perfluorochemical as additive in the barrier coating achieve the higher maximum peel forces with lower amounts of additive compared to the samples containing Ciba® Latexia® 302 as additive for a given adhesive weight.

A commercially available label, AVERY QUICK DRY® Inkjet label, is used to determine the optimum peel force necessary for such an application, using the method described above. This optimum peel force (24 hours) is determined as 7.6 N. The adhesive weight required to attain a maximum peel force of 7.6 N is calculated for each sample obtained as described in example 3A.

The results are shown in FIG. 8.

Label stock paper barrier-coated with 0.1% by dry weight organic perfluorochemical/dry weight of starch (sample 2) requires only 12 g/m² adhesive to attain a maximum peel force of 7.6 N.

Label stock paper barrier-coated with 2.2% by dry weight acrylic core shell polymer/dry weight of starch (sample 1) requires only 13 g/m² adhesive to attain a maximum peel force of 7.6 N.

Label stock paper barrier-coated with pure starch (comparative sample 1) requires 16 g/m² adhesive to attain a maximum peel force of 7.6 N.

Label stock paper barrier-coated with 6.4%, respectively, 10.6% by dry weight Ciba® Latexia® 302/dry weight of starch (comparative samples 2 and 3) require 17, respectively, 15 g/m² adhesive to attain a maximum peel force of 7.6 N.

Thus, when using label stock paper barrier-coated with 2.2% dry weight acrylic core shell polymer/dry weight starch or 0.1% organic perfluorochemical/dry weight starch, only 13 g/m², respectively, 12 g/m² adhesive is needed to attain a maximum peel force of 7.6 N compared to 15 g/m² (10.6% by dry weight Ciba® Latexia® 302), 16 g/m² (pure starch) or 17 mg/m² (6.4% by dry weight Ciba® Latexia® 302) adhesive when using the control samples.

### Example 4B

### Preparation of Adhesive-Treated Barrier-Coated Label-Stock Paper (=Adhesive-Treated Samples) Using Neat Adhesive

The coated label-stock papers obtained as described in example 3B are cut into 10×15 cm. Swift® Hot melt Adhesive B56938 supplied by Forbo is melted at 180° C. in an oil bath and 5 mL of the melted adhesive is applied on the bottom side of the barrier coating layer of the coated label-stock papers obtained as described in example 3B using a syringe. After applying the adhesive, the adhesive covered coated label-stock papers are folded with the adhesive covered side inside to get a sample with a size 7.5×10 cm. A glass plate, about 6×9 cm is placed on top of this folded adhesive treated samples. A weight of 500 g is placed on top of the glass plate so that the adhesive gets a chance to be distributed evenly. The sample is conditioned for 24 hours at room temperature.

### Brightness Testing of Adhesive-Treated Samples of Example 4B

After conditioning for 24 hours, the brightness of the adhesive covered coated label-stock papers is measured on the top side of the label stock using ISO2470 method. As a control, the brightness of the not adhesive treated coated label stock papers of example 3B are also measured on the top side of the label stock. The drop in brightness of the adhesive covered versus the not adhesive covered coated label stock papers is determined. It can be assumed that the smaller the drop in brightness is, the less adhesive is absorbed by the label stock.

The results are shown in FIG. 9.

It can be seen that the smallest drop in brightness is achieved with the barrier coating composition containing 6.6% by dry weight acrylic core shell polymer/dry weight of starch (sample 4), followed by the barrier coating composition containing 0.1% by dry weight organic perfluorochemical/dry weight of starch (sample 5), followed by the barrier coating composition containing 2.2% by dry weight acrylic core shell polymer/dry weight of starch (sample 3). All these sample show a smaller drop in brightness than the barrier coating composition containing 8.8% by dry weight Ciba® Latexia® 204/dry weight starch (comp. 3). This again shows that the labels of the present invention have a barrier coating layer that efficiently prevents the absorbtion of adhesive by the label stock, and that this is achieved with barrier coating layers having extremely small amounts of acrylic core shell polymer or organic perfluorochemical.

1. A label comprising a label stock (1), an adhesive layer (2), and a barrier coating layer (3), which is located between the bottom side of the label stock and the top side of the adhesive layer, wherein the barrier coating layer comprises either an acrylic core shell polymer or an organic perfluorochemical.

2. The label of claim 1, wherein the acrylic core polymer has a weight average molecular weight (M_{W}) of from 75,000 g/mol to 350,000 g/mol.

3. The label of claim 1, wherein the acrylic core polymer has a glass transition temperature (Tg) of below 50° C.

4. The label of claim 1, wherein the acrylic core polymer is a copolymer formed from at least one acrylic monomer and at least one styrene monomer and optionally other ethylenically unsaturated monomers.

5. The label of claim 1, wherein the acrylic shell polymer has a weight average molecular weight (M_{W}) of from 2,000 g/mol to 50,000 g/mol.

6. The label of claim 1, wherein the acrylic shell polymer has a glass transition temperature (Tg) of from 75 to 150° C.

7. The label of claim 1, wherein the acrylic shell polymer is a copolymer formed from at least one acrylic monomer having an acid functionality or salts thereof, and at least one other ethylenically unsaturated monomer.

8. The label of claim 1, wherein the ratio of acrylic shell polymer/acrylic core polymer is 10/90 to 90/10.

9. The label of claim 1, wherein the organic perfluorochemical is any organic compound being substituted with fully fluorinated di-, tri- or polyC₃₋₂₀-alkyl, C₃₋₂₀-cycloalkyl or C₃₋₂₀-alkenyl groups or mixtures thereof.

10. The label of claim 1, wherein the barrier coating layer additionally comprises starch or modified starch.

11. The label of claim 1, wherein the area weight of the barrier coating layer is from 0.1 to 20 g/m².

12. The label of claim 1, wherein the label stock can be any paper having an area weight of from 30 to 230 g/m².

13. The label of claim 1, wherein the adhesive of the adhesive layer is selected from the group consisting of naturally occurring polymers, chemically modified derivatives of naturally occurring polymers, synthetic polymers and mixtures thereof.

14. The label of claim 1, wherein the bottom side of the adhesive layer is attached to a substrate (4).

15. A process for preparing the label of claim 1 comprising the steps of
(i) forming a barrier coating composition comprising the acrylic core shell polymer, respectively, the organic perfluorochemical and optionally film forming polymer and additional components,
(ii) applying the barrier coating composition of step (i) to a label stock to form the barrier coating layer, and
(iii) applying adhesive to the barrier coating obtained in step (ii) to form the adhesive layer.

16. The process of claim 15, wherein the further component is starch or modified starch.

17. The process of claim 15 for preparing a label comprising a label stock (1), an adhesive layer (2), and a barrier coating layer (3), which is located between the bottom side of the label stock and the top side of the adhesive layer, wherein the barrier coating layer comprises either an acrylic core shell polymer or an organic perfluorochemical,
wherein the bottom side of the adhesive layer is attached to a substrate (4),
comprising the
additional step of attaching the label via the bottom side of the adhesive layer to the substrate.

18. A label precursor comprising a label stock, and a barrier coating layer at the bottom side of the label stock, wherein the barrier coating layer comprises either an acrylic core shell polymer or an organic perfluorochemical.

19. A process for preparing the label precursor of claim 18 comprising the steps of
(i) forming a barrier coating composition comprising the acrylic core shell polymer, respectively, the organic perfluorochemical and optionally film forming polymer and additional components, and
(ii) applying the barrier coating composition of step (i) to a label stock to form a barrier coating.

20. (canceled)

21. A method for reducing absorption of adhesive by the label stock in a label by applying a barrier coating layer between the bottom side of the label stock and the top side of the adhesive layer, wherein the barrier coating layer comprises either an acrylic core shell polymer or an organic perfluorochemical.
